(19) United States
(12) Patent Application Publication
(10) Pub. No.: US 2023/0153046 A1
(43) Pub. Date: May 18, 2023

(54) PRINT RESOURCE RESERVATIONS

(71) Applicant: HEWLETT-PACKARD DEVELOPMENT COMPANY, L.P., Spring, TX (US)

(72) Inventors: . ANUSHA, Bangalore (IN); Devi VELLINGIRI, Bangalore (IN); Puviyarasu VELUMANI, Bangalore (IN)

(73) Assignee: HEWLETT-PACKARD DEVELOPMENT COMPANY, L.P., Spring, TX (US)

(21) Appl. No.: 17/704,503

(22) Filed: Mar. 25, 2022

(30) Foreign Application Priority Data
Nov. 15, 2021 (IN) 202141052329

(51) Int. Cl. G06F 3/12

(52) U.S. Cl. CPC G06F 3/1226; G06F 3/126; G06F 3/1296; G06F 3/1207; G06F 3/1285; G06F 3/121

(57) ABSTRACT

An example pull-print server includes a receiver to receive a print job including a document to be printed. Further, the pull-print server includes a controller to retrieve a job specification from the print job and determine a print resource to be reserved to print the document based on the retrieved job specification. Furthermore, the pull-print server includes a notification unit to notify an image forming apparatus to reserve the determined print resource to print the document. Further, the pull-print server includes a transmitter to transmit the document to the image forming apparatus to execute the print job using the reserved print resource in response to a reception of a pull-print request.

### BACKGROUND

Image forming apparatuses, such as multifunctional peripherals (MFP), printers, and the like, may be capable of printing documents and/or images. Some printers may support a “pull printing” feature, where a pull-print server (e.g., a cloud server) may receive a print job including a document (e.g., print data) from a user device and store the print job. Further, when a user inputs a pull-print request through a printer, the printer may receive the print job from the pull-print server and perform printing.

### BRIEF DESCRIPTION OF THE DRAWINGS

Examples are described in the following detailed description and in reference to the drawings, in which:

FIG. 1 is a block diagram of an example pull-print server, including a controller to notify an image forming apparatus to reserve a print resource to print a document;

FIG. 2A depicts an example document associated with the print job, including a first page and a second page;

FIG. 2B depicts an example job specification associated with the print job;

FIG. 3A is a block diagram of an example image forming apparatus, including a print resource reservation unit to reserve a print resource to execute a print job;

FIG. 3B is a block diagram of the example image forming apparatus of FIG. 3A, depicting additional features;

FIG. 4A is an example user interface, depicting an example media level with media reservation corresponding to a print job;

FIG. 4B is an example user interface, depicting an example ink level with ink reservation corresponding to a print job;

FIG. 5 is a block diagram of an example pull-print server including non-transitory machine-readable storage medium storing instructions to reserve a print resource on a set of network-connected image forming apparatuses; and

FIG. 6 is a flowchart illustrating an example method for reserving a print resource on image forming apparatuses for executing a print job.

### DETAILED DESCRIPTION

In an enterprise environment, multiple computing devices (e.g., client devices) may be connected to image forming apparatuses (e.g., printers) over a network. Pull printing may refer to a printing feature where a print job can be held on a pull-print server (e.g., server-based pull printing) or on a client device/image forming apparatus (e.g., serverless pull printing) and released by a user at the image forming apparatus (e.g., a printer), which supports the printing feature. Example print job may include a document to be printed in accordance with a job specification (e.g., a number of copies, color or black/while print, a media size, and the like).

In server-based pull printing, the print job initiated from a user device may be sent to the pull-print server. Further, the pull-print server may map the print job to the user's account in the pull-print server. Furthermore, the image forming apparatus may receive the print job from the pull-print server and perform printing of the document in accordance with the job specification when the user inputs a print request through the image forming apparatus. In this example, the user may authenticate the print job at the image forming apparatus using security measures, such as personal identification number (PIN), a password, a smartcard, or the like, to release the print job. Similarly, in serverless pull printing, the print job may be held on the client device or the image forming apparatus until released by the user.

In some example pull printing scenarios, when the user pulls the print job from the server via an image forming apparatus, the image forming apparatus may not be able to execute the print job due to various reasons such as unavailable print resources (e.g., media, ink/toner, or the like), the image forming apparatus being in an error state (e.g., a connectivity issue, a paper jam, or the like), or the like. Therefore, the user may end up going to the image forming apparatus and not receiving the requested prints, which may lead to a wastage of user's time and affect user experience.

Examples described herein may provide a pull-print server to reserve a print resource on image forming apparatuses. The pull-print server may receive a print job. The pull-print server may retrieve a job specification from the print job. The job specification may indicate a media size, a media type, a quantity of media, a percentage of toner or ink, or any combination thereof. Further, the pull-print server may determine a print resource (e.g., media, ink/toner, and the like) to be reserved to execute the print job based on the job specification. Furthermore, the pull-print server may instruct network-connected image forming apparatuses to reserve the determined print resource. The pull-print server may receive an acknowledgement message from the image forming apparatuses. The acknowledgement message may indicate an availability status of the print resource. The pull-print server may send a notification indicating the print resource availability status of the image forming apparatuses to a user device. Upon receiving a pull-print request, the pull-print server may transmit the print job to an image forming apparatus to execute the print job using the reserved print resource.

Thus, examples described herein may enable a pull-print server to determine a print resource to be reserved to execute a print job and instruct a network-connected image forming apparatus to reserve the determined print resource to print the document associated with the print job. Reserving the print resource to execute the print job may avoid the wastage of user's time and also enhance the user experience.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

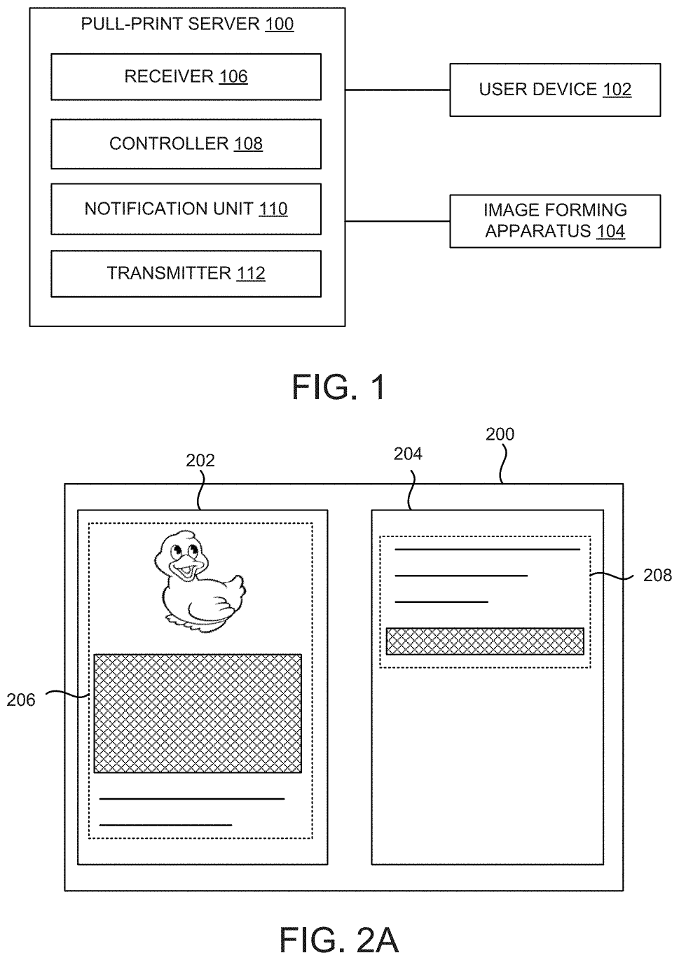

Turning now to the figures, FIG. 1 is a block diagram of an example pull-print server 100, including a controller 108 to notify an image forming apparatus 104 to reserve a print resource to print a document. As shown in FIG. 1, pull-print server 100 is communicatively coupled to a user device 102 (e.g., corresponding to a user) and image forming apparatus 104 via a network. Example network may be a local area network (LAN), a wide area network (WAN), the Internet, and/or the like. An example network printing environment of FIG. 1 is illustrated using one user device (i.e., user device 102) and image forming apparatus 104, however, the network printing environment can include multiple user devices communicatively connected to multiple image forming apparatuses via pull-print server 100.

Example user device 102 is an electronic device supporting a printing application to generate a print job for printing. For example, user device 102 is a laptop, a desktop, a mainframe computer, a smartphone, a personal digital assistant (PDA), an Internet of Things (loT) device, or the like. Further, user device 102 may include a printer driver (e.g., to support the printing application) that is either installed in or accessible to user device 102 to generate the print job and send the print job for printing. Example image forming apparatus 102 may be a single function peripheral (SFP) or a multi-function peripheral (MFP). For example, image forming apparatus 102 is a laser beam printer (e.g., using an electrophotographic method for printing), an ink jet printer (e.g., using an ink jet method for printing), or the like.

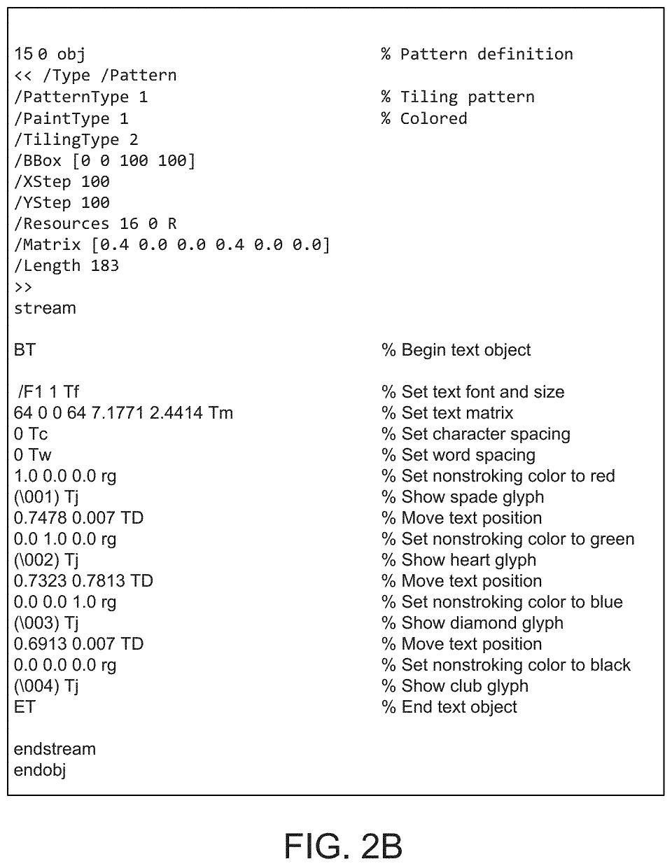

As shown in FIG. 1, pull-print server 100 includes a receiver 106, controller 108, a notification unit 110, and a transmitter 112. During operation, receiver 106 may receive from client device 102, a print job including a document to be printed. The print job may include the document to be printed in accordance with a job specification. The job specification may include data indicative of a media size, a media type, a quantity of media, a percentage of print material, or any combination thereof. In an example, the document includes a single page or multiple pages. An example document 200 including a first page 202 and a second page 204 is depicted in FIG. 2A. In the example shown in FIG. 2A, first page 202 and second page 204 include content 206 and 208, respectively, to be printed. Further, FIG. 2B depicts an example job specification associated with the print job (i.e., to print document 200 of FIG. 2A). For example, a print driver (e.g., a PDF driver, a postscript driver, a PCLm driver, or the like) generates the print job with the specification including multiple objects. As shown in FIG. 2B, the objects may include text stream, images, other multimedia elements, and the like. Also, the job specification may include colors for the objects in an array. An example object is shown in FIG. 2B.

Referring back to FIG. 1, controller 108 may retrieve the job specification from the print job. For example, controller 108 includes a print job parser (e.g., a printer job language (PJL) parser, a PostScript, a printer control language (PCL) parser, or the like) to process the print job and retrieve the job specification. Further, controller 108 may determine a print resource to be reserved to print the document based on the retrieved job specification. In an example, controller 108 determines a quantity of media (e.g., number of papers) having a media size and a media type to be reserved based on the job specification.

In another example, controller 108 may determine an amount of print material (i.e., ink/toner) to be reserved corresponding to each color based on the job specification when the print job is a color print job. In yet another example, controller 108 may determine an amount of black print material to be reserved based on the job specification when the print job is a monochrome black print job. For example, controller 108 processes print job stream data (e.g., red, green, and blue (RGB) raster data) from the job specification as depicted in FIG. 2B and convert these RGB data to equivalent cyan, magenta, yellow, and key (black) (CMYK) data for printing. The CMYK data may provide details of approximate toner consumption for each color for the print job. For example, the objects as shown in FIG. 2B may have associated color values. From the color values of each object, total coverage for entire page can be calculated in RGB format. Then, the color values can be converted to equivalent CMYK values.

The amount of print material to be reserved may indicate an amount of print material that can be consumed to print the document. In the example of FIG. 2A, controller 108 determines the amount of print material that can be consumed to print first page 202 and second page 204 based on the job specification. In other examples, controller 108 determines the amount of print material coverage for first page 202 by determining a ratio of a number of pixels to be printed to a total number of printable pixels in first page 202. Similarly, controller 108 determines the amount of print material coverage for second page 204 by determining a ratio of a number of pixels to be printed to a total number of printable pixels in second page 204. In an example, the print material coverage may be a sum of color print material coverages when the print job is a color print job. In another example, the print material coverage may be a black print material coverage when the print job is a monochrome black print job.

For example, first page 202 and second page 204 may include monochrome contone objects, color contone objects, monochrome text objects, color text objects, monochrome line art objects, color line art objects, monochrome graphic objects, color graphic objects, monochrome low frequency halftone objects, color low frequency halftone objects, monochrome high frequency halftone objects, color high frequency halftone objects, monochrome solid fill objects, color solid fill objects, and/or the like. Further, an “object” may refer to color critical content contained within the document. The objects may be positioned on a background, composed of white space or other uniformly colored background and include, for example, text, pictures, graphics, charts, images, and the like.

Referring back to FIG. 1, notification unit 110 may notify image forming apparatus 104 to reserve the determined print resource to print the document. In an example, notification unit 110 instructs image forming apparatus 104 to reserve the determined print resource for a defined time limit. In this example, the reservation can be active for a specified time limit (e.g., 2 hours). Further, the time limit can be user configurable within the maximum value (e.g., as set by an administrator of image forming apparatus 104). During the time limit, image forming apparatus 104 may reserve the print resource for the print job irrespective of other print jobs (e.g., active/scheduled print jobs). In other words, the reserved print resource cannot be utilized to execute other print jobs for the defined time limit.

Furthermore, transmitter 112 may transmit the document to image forming apparatus 104 to execute the print job using the reserved print resource in response to a reception of a pull-print request. In an example, controller 108 may receive the pull-print request from the user via image forming apparatus 104. Further, controller 108 may authenticate the user based on authentication information prior to the transmission of the document to image forming apparatus 104. In an example, the user provides authentication information at image forming apparatus 104 using security measures such as a personal identification number (PIN), password, smartcard, or the like to release the print job. Further, image forming apparatus 104 may send the pull-print request including the authentication information to pull-print server 100 to obtain the print job and perform printing.

In some examples, the functionalities described herein, in relation to instructions to implement functions of receiver 106, controller 108, notification unit 110, transmitter 112, and any additional instructions described herein in relation to the storage medium, may be implemented as engines or modules including any combination of hardware and programming to implement the functionalities of the modules or engines described herein. The functions of receiver 106, controller 108, notification unit 110, and transmitter 112 may also be implemented by a processor. In examples described herein, processor may include, for example, one processor or multiple processors included in a single device or distributed across multiple devices.

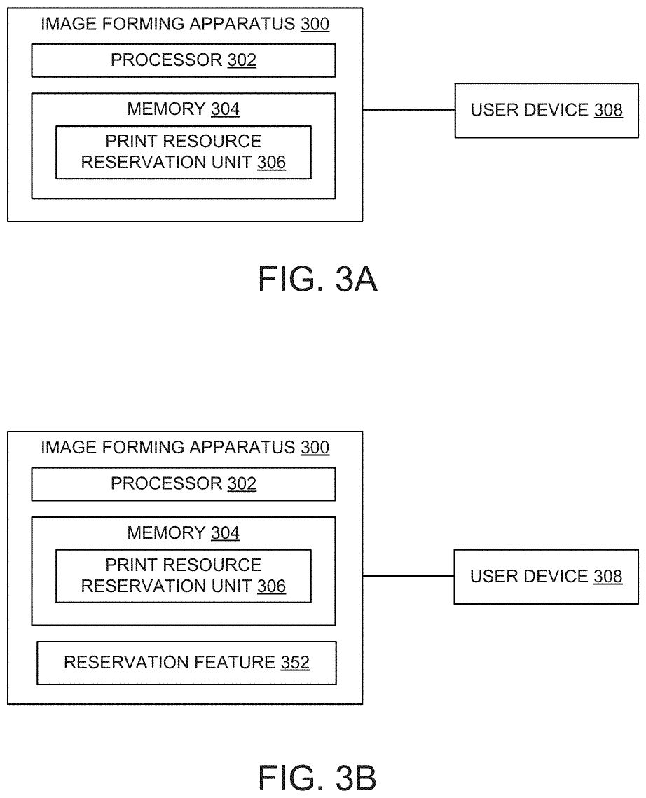

FIG. 3A is a block diagram of an example image forming apparatus 300, including a print resource reservation unit 306 to reserve a print resource to execute a print job. Example image forming apparatus 300 includes a processor 302 and a memory 304 coupled to processor 302. Processor 302 may be any type of central processing unit (CPU), microprocessor, or processing logic that interprets and executes machine-readable instructions stored in memory 304. Further, memory 304 includes print resource reservation unit 306.

During operation, print resource reservation unit 306 may receive a print job including a document to be printed. In an example, print resource reservation unit 306 receives the print job from a user device 308 corresponding to a user. User device 308 may be communicatively connected to image forming apparatus 300 via a network. The network may be a local area network (LAN), a wide area network (WAN), the Internet, and/or the like. User device 308 may be an electronic device supporting a printing application to generate the print job. For example, user device 308 can be a laptop, a desktop, a mainframe computer, a smartphone, a personal digital assistant (PDA), an Internet of Things (loT) device, or the like. Further, user device 308 may include a printer driver (e.g., to support the printing application) that is either installed in or accessible to user device 308 to generate the print job and send the print job to image forming apparatus 300 for printing.

In another example, image forming apparatus 300 may include an email-based print function which allows the user to print the document by emailing the document to an email address associated with image forming apparatus 300. The document to be printed may be held on user device 308 or image forming apparatus 300 until released by the user. Further, print resource reservation unit 306 may determine that the print job includes an instruction to reserve a print resource to print the document.

Furthermore, print resource reservation unit 306 may estimate the print resource to be reserved to print the document based on job details associated with the print job. In an example, print resource reservation unit 306 is to:
determine a quantity of media to be reserved,
determine a type of the media and a quantity of the media to be reserved,
determine a size of the media and a quantity of the media to be reserved,
determine a type of the media, a size of the media, and a quantity of the media to be reserved,
determine an amount of print material to be reserved, or
any combination thereof.

In an example, print resource reservation unit 306 converts RGB data of the document to be printed to CMYK data. Further, print resource reservation unit 306 determines an amount of print material to be reserved corresponding to each color using the CMYK data.

Further, print resource reservation unit 306 may determine an availability of the estimated print resource at image forming apparatus 300. Furthermore, print resource reservation unit 306 may reserve the estimated print resource based on the availability of the estimated print resource. Upon reserving the print resource, print resource reservation unit 306 may send a notification indicating the availability of the print resource or an unavailability of the print resource to user device 308 from which the print job is originated. Furthermore, print resource reservation unit 306 may execute the print job to print the document using the reserved print resource in response to a reception of a pull-print request. The pull-print request may be provided via a user interface (e.g., a control panel) of image forming apparatus 300.

FIG. 3B is a block diagram of example image forming apparatus 300 of FIG. 3A, depicting additional features. Similarly named elements of FIG. 3B may be similar in function and/or structure to elements described in FIG. 3A. As shown in FIG. 3B, image forming apparatus 300 includes a reservation feature 352. When reservation feature 352 is enabled, print resource reservation unit 306 may allow reservation of the print resource for executing the print job. In another example, when reservation feature 352 is disabled, print resource reservation unit 306 may send a notification to user device 308, the notification indicating that the print resource cannot be reserved on image forming apparatus 300.

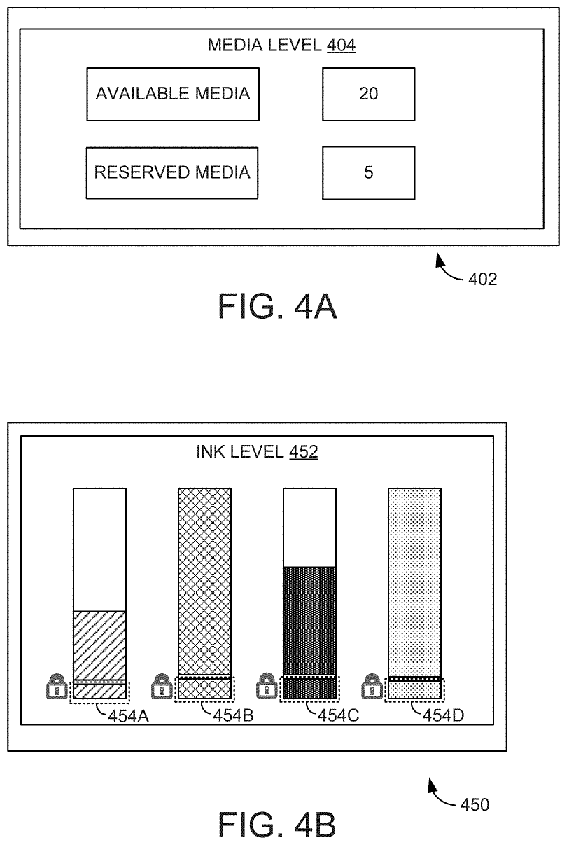

FIG. 4A is an example user interface 402, depicting an example media level 404 with media reservation corresponding to an image forming apparatus (e.g., image forming apparatus 300 of FIG. 3A). Example user interface 402 is a display panel of image forming apparatus 100. In other examples, user interface 402 may be associated with an embedded web server (EWS), a mobile application, and the like. When the image forming apparatus has the print resources available to execute the print job, then the image forming apparatus locks the print resources corresponding to the print job and update the status accordingly.

In the example shown in FIG. 4A, upon reserving the print resource to print the document, media level 404 is represented on user interface 402. As shown in FIG. 4A, consider that the image forming apparatus has 25 A4 sheets loaded/remaining in a tray and the number of media reserved for a first print job is 5 A4 sheets. In this example, user interface 402 (e.g., a control panel) displays 20 A4 sheets as available and 5 A4 sheets as reserved. Further, consider that the number of media reserved for a second print job is 4 A4 sheets. In this example, user interface 402 displays 16 A4 sheets as available and 9 A4 sheets (5 sheets reserved for the first print job+4 sheets reserved for the second print job) as reserved.

FIG. 4B is an example user interface 450, depicting an example ink level 452 with ink reservation corresponding to an image forming apparatus (e.g., image forming apparatus 300 of FIG. 3A). Upon reserving the print resource to print the document, ink level 452 including remaining ink and reserved ink may be displayed on user interface 450. For a toner/ink status (i.e., ink level 452), user interface 450 may display a lock symbol for the reserved percentage of toner/ink for different colors as shown in FIG. 4B. Thus, when the image forming apparatus includes a print resource that has to be reserved for executing a print job, then the image forming apparatus may lock the print resource (e.g., ink corresponding to each color (e.g., cyan as shown by 454A, magenta as shown by 454B, yellow as shown by 454C, and black as shown by 454D) for the print job and update the status (e.g., media level 404 of FIG. 4A and ink level 452 of FIG. 4B) accordingly.

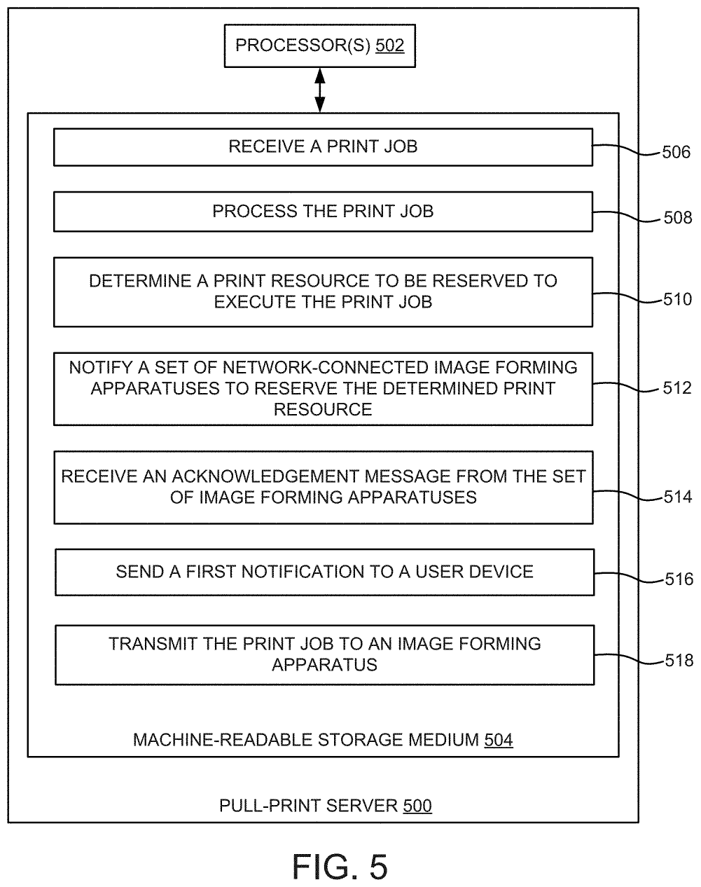

FIG. 5 is a block diagram of an example pull-print server 500 including non-transitory machine-readable storage medium 504 storing instructions to reserve a print resource on a set of network-connected image forming apparatuses. Example pull-print server 500 may be a device that connect image forming apparatuses to user devices over a network. Example pull-print server 500 may act as an intermediary between the user devices and image forming apparatuses, accepting print jobs from the user devices, and sending them on to an appropriate image forming apparatus. In some examples, pull-print server 500 may be an on-premises server or a cloud-based server (e.g., including a cloud printing service). Pull-print server 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504.

Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), rambus DRAM (RDRAM), rambus RAM, and the like, or storage memory media such as a floppy disk, a hard disk, a CD-ROM, a DVD, a pen drive, and the like. In an example, machine-readable storage medium 504 may be non-transitory machine-readable medium. Machine-readable storage medium 504 may be remote but accessible to pull-print server 500.

As shown in FIG. 5, machine-readable storage medium 504 may store instructions 506, 508, 510, 512, 514, 516, and 518. Instructions 506 may be executed by processor 502 to receive a print job. For example, the print job may include a document to be printed and a job specification.

Instructions 508 may be executed by processor 502 to process the print job to retrieve the job specification. In an example, instructions to process the print job to retrieve the job specification include instructions to process the print job to retrieve a media type, a media size, a quantity of media, a percentage of toner or ink to be consumed, or any combination thereof for executing the print job.

Instructions 510 may be executed by processor 502 to determine a print resource to be reserved to execute the print job based on the retrieved job specification. In an example, when the image forming apparatus is a color printer, instructions to determine the print resource to be reserved include instructions to:
convert red, green, and blue (RGB) data of the document to be printed to cyan, magenta, yellow, and black (CMYK) data, and
determine an amount of print material to be reserved corresponding to each color using the CMYK data.

In another example, when the image forming apparatus is a monochrome printer, instructions to determine the print resource to be reserved include instructions to determine an amount of black print material to be reserved using the RGB data.

Instructions 512 may be executed by processor 502 to notify a set of network-connected image forming apparatuses to reserve the determined print resource. In an example, instructions to notify the set of network-connected image forming apparatuses include instructions to:
determine the set of network-connected image forming apparatuses that are within a threshold distance from a user device using network information of the user device from which the print job is originated and network information of the image forming apparatuses, and
notify the set of network-connected image forming apparatuses that are within the threshold distance to reserve the determined print resource.

Instructions 514 may be executed by processor 502 to receive an acknowledgement message from the set of image forming apparatuses. In an example, the acknowledgement message may include an availability status of the print resource.

Instructions 516 may be executed by processor 502 to send a first notification indicating the availability status of the set of image forming apparatuses to a user device. Instructions 518 may be executed by processor 502 to transmit the print job to an image forming apparatus of the set of image forming apparatuses to execute the print job using the reserved print resource based on the availability status upon receiving a pull-print request. In an example, instructions to transmit the print job to the image forming apparatus include instructions to:
in response to sending the first notification, receive a request to execute the print job on the image forming apparatus having an availability of the print resource, and
transmit the print job to the image forming apparatus upon receiving the pull-print request from the image forming apparatus.

In another example, instructions to transmit the print job to the image forming apparatus include instructions to:
in response to sending the first notification, receive a request to execute the print job on the image forming apparatus having an unavailability of the print resource,
poll, at defined intervals, the image forming apparatus to determine the availability status of the print resource,
reserve the print resource when the availability status indicates an availability of the print resource to execute the print job,
send a second notification to the user device, the second notification indicating the availability of the print resource on the image forming apparatus, and
transmit the print job to the image forming apparatus upon receiving the pull-print request from the image forming apparatus.

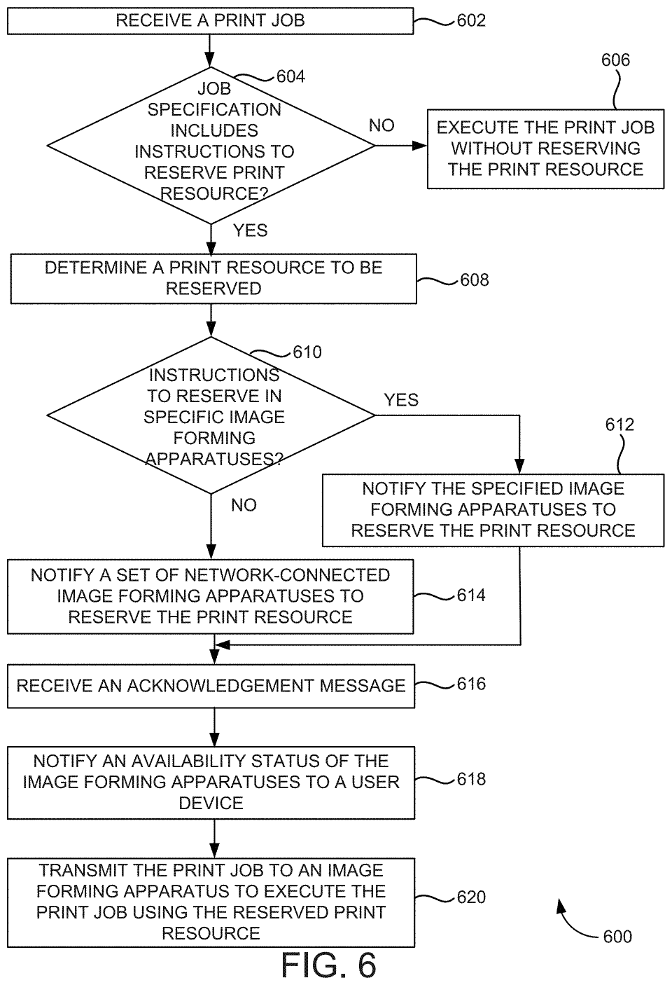

FIG. 6 is a flowchart illustrating an example method 600 for reserving a print resource on image forming apparatuses for executing a print job. Example method 600 may represent generalized illustrations, and that other processes may be added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. The processes of method 600 may represent functions and/or actions performed by functionally equivalent circuits like analog circuits, digital signal processing circuits, application specific integrated circuits (ASICs), or other hardware components associated with the system. Furthermore, example method 600 may not be intended to limit the implementation of the present application, but example method 600 may illustrate functional information to design/fabricate circuits, generate machine-readable instructions, or use a combination of hardware and machine-readable instructions to perform the illustrated processes.

In an example, a “secure pull print” program can be installed in an organization's network and a secured shared storage can be enabled. The storage may be a cloud storage or an inbuilt storage server. Further, the image forming apparatuses in the organization's network may be enabled with a “secure pull print” option. Furthermore, the users in the organization may be given access to the “secure pull print” program such that the users can print documents using this program in any image forming apparatus which is connected to the organization's network and has the “secure pull print” enabled. Further, the “secure pull print” program may include a “reserve resource” option along with a reservation time limit.

At 602, a print job is received by a pull-print server from a user device. An example print job includes a document to be printed and a job specification indicating instructions to print the document. At 604, the job specification associated with the print job is retrieved and a check is made to determine whether the job specification includes instructions to reserve a print resource to print the document. In an example, a user selects the “reserve resource” option (e.g., as a part of print setting) to reserve the print resource while launching the print job. When the job specification does not include instructions to reserve the print resource, the print job is executed at an image forming apparatus without reserving the print resource, at 606.

At 608, when the job specification includes instructions to reserve the print resource, the print resource to print the document is determined. For example, the print resource includes a required media type, a media size, a number of media, a percentage of toner/ink required to print the document, and the like. In an example, determining an amount of ink to print the document includes estimating an amount of print material coverage for each page of the document. Estimating the amount of print material coverage may include:
detecting a number of objects in a page,
determining a type of the detected objects within the page,
determining an amount of dot area coverage in a region of the detected objects, and
estimating the amount of print material coverage for the page based on the number of objects within the page, the type of the objects, and the amount of dot area coverage for the objects.

At 610, a check is made to determine whether the job specification includes instructions to reserve the print resource in specific image forming apparatuses. For example, while launching the print job, the user can choose specific network-connected image forming apparatuses (e.g., image forming apparatuses within a proximity of the user device, image forming apparatuses located in a particular floor, or the like) to reserve the print resource. When the job specification includes instructions to reserve the print resource in the specific image forming apparatuses, a notification to reserve the print resource is sent to the specified image forming apparatuses, at 612. For example, consider that the “secure pull print” network includes 10 printers, and the user has selected the option “reserve only nearby printers”. On enabling “reserve only nearby printers” option, the secure pull print server reserves the print resources in the first 3 printers that are in proximity. The pull-print server may determine the proximity using device network details from which the print job is originated, and the printer network details, for instance.

At 614, when the job specification does not include instructions to reserve the print resource in the specific image forming apparatuses, a notification to reserve the print resource is sent to a set of network-connected image forming apparatuses (e.g., the 10 printers) in the “secure pull print” network.

At 616, an acknowledge message is received from the image forming apparatuses. In an example, when the image forming apparatuses receive the notification to reserve the print resource, the image forming apparatuses may then check its available resource versus required resource. If the print resource is available, a status of the image forming apparatuses may be updated (e.g., as shown in FIGS. 4A and 4B). If the print resource is not available in some of the image forming apparatuses in the “secure pull print” network or some of the image forming apparatuses printer are in an erroneous state, a notification including the unavailability status of the image forming apparatuses may be received by the pull-print server accordingly.

At 618, the availability status of the image forming apparatuses is notified to the user device. The pull-print server may consolidate data using the availability/unavailability status of the image forming apparatuses and warn the user with the “unavailable printer” list. The list may have the image forming apparatuses that could not be currently reserved for the print job. At 620, the print job is transmitted to an image forming apparatus to execute the print job using the reserved print resource upon receiving a pull-print request.

In other examples, when the user is looking for a specific image forming apparatus from the “unavailable printer” list to be locked on availability, then the user can request the same by selecting a checkbox provided against each image forming apparatus of the “unavailable printer” list. The pull-print server may keep polling the specified image forming apparatus's status (e.g., within a limited duration or till the job is not printed) and lock the print resource on the specified image forming apparatus once the specified image forming apparatus is available. The pull-print server may also notify the user regarding the availability of the specified image forming apparatus.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

1. A pull-print server comprising:
a receiver to receive a print job including a document to be printed;
a controller to:
retrieve a job specification from the print job; and
determine a print resource to be reserved to print the document based on the retrieved job specification;
a notification unit to notify an image forming apparatus to reserve the determined print resource to print the document; and
a transmitter to transmit the document to the image forming apparatus to execute the print job using the reserved print resource in response to a reception of a pull-print request.

2. The pull-print server of claim 1, wherein the job specification comprises data indicative of a media size, a media type, a quantity of media, a percentage of print material, or any combination thereof.

3. The pull-print server of claim 1, wherein the notification unit is to instruct the image forming apparatus to reserve the determined print resource for a defined time limit.

4. The pull-print server of claim 1, wherein the controller is to:
determine a quantity of media having a media size and a media type to be reserved based on the job specification.

5. The pull-print server of claim 1, wherein the controller is to:
determine an amount of print material to be reserved corresponding to each color based on the job specification when the print job is a color print job; or
determine an amount of black print material to be reserved based on the job specification when the print job is a monochrome black print job.

6. An image forming apparatus comprising:
a processor; and
a memory coupled to the processor, wherein the memory comprises a print resource reservation unit to:
receive a print job including a document to be printed;
determine that the print job includes an instruction to reserve a print resource to print the document;
estimate the print resource to be reserved to print the document based on job details associated with the print job;
determine an availability of the estimated print resource;
reserve the estimated print resource based on the availability of the estimated print resource; and
execute the print job to print the document using the reserved print resource in response to a reception of a pull-print request.

7. The image forming apparatus of claim 6, wherein the print resource reservation unit is to:
determine a quantity of media to be reserved;
determine a type of the media and a quantity of the media to be reserved;
determine a size of the media and a quantity of the media to be reserved;
determine a type of the media, a size of the media, and a quantity of the media to be reserved;
determine an amount of print material to be reserved; or
any combination thereof.

8. The image forming apparatus of claim 6, wherein the print resource reservation unit is to:
send a notification indicating the availability of the print resource or an unavailability of the print resource to a user device from which the print job is originated.

9. The image forming apparatus of claim 6, further comprising:
a reservation feature, wherein, upon enabling the reservation feature, the print resource reservation unit is to allow reservation of the print resource for executing the print job.

10. The image forming apparatus of claim 6, wherein the print resource reservation unit is to:
convert red, green, and blue (RGB) data of the document to be printed to cyan, magenta, yellow, and black (CMYK) data; and
determine an amount of print material to be reserved corresponding to each color using the CMYK data.

11. A non-transitory computer-readable storage medium encoded with instructions that, when executed by a processor of a pull-print server, cause the processor to:
receive a print job;
process the print job to retrieve a job specification;
determine a print resource to be reserved to execute the print job based on the retrieved job specification;
notify a set of network-connected image forming apparatuses to reserve the determined print resource;
receive an acknowledgement message from the set of image forming apparatuses, the acknowledgement message indicating an availability status of the print resource;
send a first notification indicating the availability status of the set of image forming apparatuses to a user device; and
upon receiving a pull-print request, transmit the print job to an image forming apparatus of the set of image forming apparatuses to execute the print job using the reserved print resource based on the availability status.

12. The non-transitory computer-readable storage medium of claim 11, wherein instructions to notify the set of network-connected image forming apparatuses comprise instructions to:
determine the set of network-connected image forming apparatuses that are within a threshold distance from a user device using network information of the user device from which the print job is originated and network information of the image forming apparatuses; and
notify the set of network-connected image forming apparatuses that are within the threshold distance to reserve the determined print resource.

13. The non-transitory computer-readable storage medium of claim 11, wherein instructions to process the print job to retrieve the job specification comprise instructions to:
process the print job to retrieve a media type, a media size, a quantity of media, a percentage of toner or ink to be consumed, or any combination thereof for executing the print job.

14. The non-transitory computer-readable storage medium of claim 11, wherein instructions to determine the print resource to be reserved comprise instructions to:
when the image forming apparatus is a color printer,
convert red, green, and blue (RGB) data of the document to be printed to cyan, magenta, yellow, and black (CMYK) data; and
determine an amount of print material to be reserved corresponding to each color using the CMYK data; and
when the image forming apparatus is a monochrome printer, determine an amount of black print material to be reserved using the RGB data.

15. The non-transitory computer-readable storage medium of claim 11, wherein instructions to transmit the print job to the image forming apparatus comprise instructions to:
in response to sending the first notification, receive a request to execute the print job on the image forming apparatus having an unavailability of the print resource;
poll, at defined intervals, the image forming apparatus to determine the availability status of the print resource;
reserve the print resource when the availability status indicates an availability of the print resource to execute the print job;
send a second notification to the user device, the second notification indicating the availability of the print resource on the image forming apparatus; and
transmit the print job to the image forming apparatus upon receiving the pull-print request.
